(19) United States
(12) Patent Application Publication
(10) Pub. No.: US 2008/0092241 A1
(43) Pub. Date: Apr. 17, 2008

(54) PROVISION AND USE OF DIGITAL RIGHTS DATA FOR EMBEDDED CONTENT OVER NETWORKED SYSTEMS

(75) Inventors: Jay C. Weber, Menlo Park, CA (US); Anthony S. Parisi, San Francisco, CA (US)

Correspondence Address: BEYER WEAVER LLP, P.O. BOX 70250, OAKLAND, CA, 94612-0250, US

(73) Assignee: MEDIA MACHINES, INC., San Francisco, CA (US)

(21) Appl. No.: 11/548,618

(22) Filed: Oct. 11, 2006

(51) Int. Cl. H04L 9/32

(52) U.S. Cl. 726/27

(57) ABSTRACT

Content browsers determine and enforce the digital rights of one piece of multimedia content to embed another. Such digital rights are encoded as data inside the content, as data in associated files, or managed by digital rights network services. In one example, Web browsers determine digital rights by comparing URLs of the embedding and embedded content, potentially with the help of digital rights Web services.

### TECHNICAL FIELD

This relates to content browser software that combines content from multiple sources made available through server software operating over communication networks, and more specifically, server and browser software providing and using digital rights data pertaining to said content combinations.

### BACKGROUND

In general, Digital Rights Management (DRM) concerns tracking and enforcement of the scope of use of specific pieces of content expressed in particular contexts. For example, the copyright holder of a song may wish to stipulate that the song should only be played on certain equipment in certain venues. DRM technology enforces such wishes via data in content and methods in playback equipment.

### SUMMARY

In accordance with an example, it is determined whether a multimedia document (the “outer” content) has the digital rights to embed external media (the “inner” content). This digital rights check is accomplished by comparing metadata known about the outer content against metadata for the inner content. Networked-content browsers perform this check with the optional assistance of digital rights network services.

### BRIEF DESCRIPTION OF FIGURES

FIG. 1 depicts examples of the relationship of inner content embedded in outer content.

FIG. 2 depicts a high-level architecture of a networked content browser, with built-in and plug-in media handlers.

FIG. 3 depicts network separation of inner and outer content.

FIG. 4 depicts two architectures, one where inner content digital rights data is provided by the same agency that provides the inner content itself, and another where said data is provided a trusted third-party digital rights service.

FIG. 5 depicts two examples of encoding digital rights information into inner content, either directly or through a reference to a network data source.

FIG. 6 is a flowchart depiction of a browser's digital rights decision procedure, that is, what information to consult on what network services before displaying inner content.

### DETAILED DESCRIPTION

The World Wide Wed (Web) has a Digital Rights Management problem that stems from one of its great architectural strengths. It is technically extremely easy to embed pieces of content (what we will call inner content) inside other pieces of content (what we will call outer content), if the outer content's author knows the URL of the inner content. E.g., the author of an HTML page can embed an image using the SRC tag, or a video using the OBJECT and/or EMBED tags. This flexibility has helped the Web explode in content and applications, but it has also led to widespread copyright violations and confusion, e.g., bloggers embedding a copyrighted photo from CNN.com. Note that the common mechanisms for Web Access Control, passwords and cookies, do not solve this problem. This problem is not so much that unauthorized users are viewing the photo, but that they are viewing it in the wrong context, i.e., outside of CNN's site and stories.

This problem also lies at the heart of new systems for Virtual Item economies. For example, Cyworld.com charges real money for the right to display graphical representations of objects on one's Cyworld page (in particular, in the “mini-room”). Such virtual objects only have value if their scope of use is tightly controlled, as the virtual couch's value goes to zero if it is easy to copy the couch from someone else's page. (If it sounds weird that people pay real money for such virtual items, think of the more conventional collectable hobbies of baseball cards and Beanie Babies, where their physicality is much less important than their artificial scarcity.)

Cyworlds's virtual item economy works because the mini-rooms' virtual items all originate from one network server location, which integrates the media before sending to the client media browsers. That way, Cyworld may completely determine and enforce the digital rights of items in mini-rooms. (It doesn't matter that one could use image manipulation software to create an image of any item in any mini-room, because Cyworld's users are trained to respect that such images must be served by Cyworld itself in order to have value, just as “unlicensed” collectible copies have little or no value.)

However, Cyworld's DRM solution does not generalize to the cases where the media containers and the embedded media clips are provided by independent media servers from independent organizations. A Web browser retrieves the container and the clip separately over the network, and integrates the media in the browser. Thus the browser can play a critical role in managing the digital rights of the media combination.

Myspace.com has a partial solution to DRM for containers and clips retrieved separately by Web browsers. Myspace allows its members to put a music player, playing a particular tune, on their profile pages. Myspace's policy, presumably stemming from their licensing terms with the music companies, is that the music player can only appear on Myspace pages, and cannot be cut/pasted to other web pages. The Myspace site design enforces this scope of use by having profile pages issue a tamper-resistant, time-limited code that the player must send the server when initializing itself and requesting the music stream from the server. Thus if a user cut/pastes the player to another page, after the code expires the player will fail in its request to retrieve the music stream.

Myspace's player DRM scheme works because Myspace controls both the page containing the player, and the server of the copyrighted material (music). However it will not work for a third-party who wishes to enforce DRM on how its content appears on Myspace pages, without active assistance from the Myspace system. It may be impractical for such third-parties to procure the active assistance from all web content providers in their desired scope of use.

The inventors have realized there is a need for a system that encodes and enforces digital rights of media clips embedded in media containers, where the clips and containers may be provided by different media servers and organizational entities, and the digital rights data is under the control of the media clip copyright holder.

For example, the inner and outer content may be World-Wide-Web documents, the networked-content browser may be a Web browser, and the content metadata may be the Uniform Resource Locators (URLs) of the documents. For example, when an HTML document contains a URL for an embedded video, a Web browser can check to see whether that combination is permitted before rendering. The relation that determines whether the specific combination of URLs is permitted can be encoded inside either document, or in the implementation of a network service that takes two URLs as input and outputs a permission value. This functionality can be implemented either as part of the Web browser code itself, or inside browser plug-ins specific to certain media types

Other networked-content browsers can employ such a method. Video game software, and the related category of Virtual Worlds, increasingly accesses networked content and thereby acts in many ways like a browser. In such cases, for example, the outer content may be a 3D scene (landscape, room, etc.) and the inner content may be the objects (animals, buildings, etc.) placed therein. As another example, the outer content may be a user's avatar and the inner content an article of clothing or weapon. Even if the scenes, objects, avatars, and clothing are provided by disparate authors over independent network services, their digital rights may be managed.

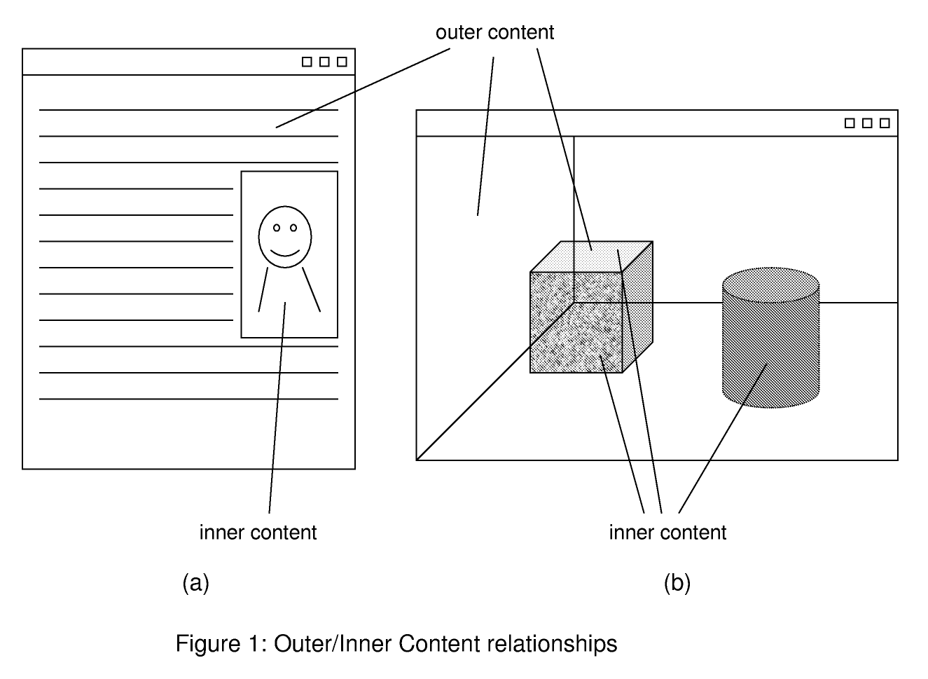

FIG. 1 shows two examples of inner content embedded in outer content. FIG. 1(a) illustrates an image embedded in a document that is two-dimensional and largely textual, as is common in our preferred embodiment of HTML pages rendered by Web browsers. Many inner content image types are in common use, e.g.: 2D static raster images in formats like JPEG, GIF, PNG; 2D vector image formats like SVG; 2D video formats like Flash video, AVI, WMV, MPEG, Quicktime; 2.5D interactive formats like Flash; 3D interactive formats like VRML and X3D (ISO/IEC 19775:2004).

FIG. 1(b) illustrates another form of content embedding, where the outer content is a 3D scene. The figure shows 3D objects as inner content, but also any 2D media can be inner content in 3D outer content, mapped onto any surface in the scene. Indeed it is a common practice in 3D modeling and rendering to map 2D raster images onto 3D surfaces, called texturing. It is also not uncommon to map videos, HTML, and Flash as textures.

The cube in FIG. 1(b) illustrates that outer/inner content relationships are relative and potentially hierarchical. That is, the cube is both inner content (with respect to the outer content room scene) and outer content (with respect to the inner content texture on the front face). So in that case and potentially many others, there are multiple levels of content embedding.

An aspect of such an embedding is that the outer and inner content may be authored independently, stored on separate files, and in a networked system, stored on separate servers. That puts the browser (or more generally, the content renderer) in the position of combining the two per instructions in the outer content, but potentially against the wishes of the owners of the inner content. This is where the browser may take an active role in digital rights management.

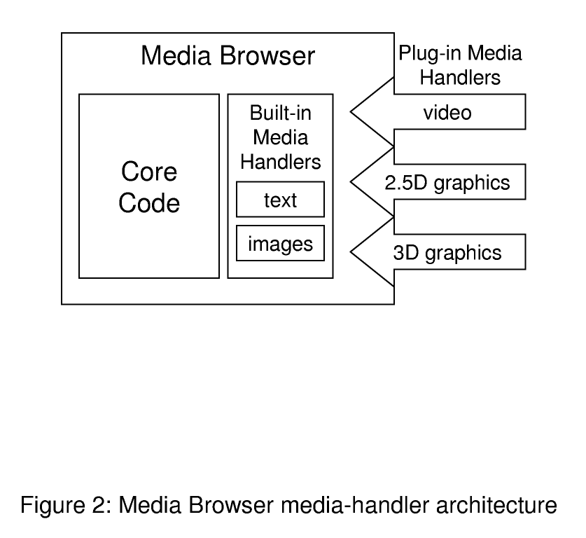

FIG. 2 shows a high-level architecture of media handling in browsers, including Web browsers. Browsers by nature handle multiple media and combinations thereof through media handler modules. These modules may either be built-in components of the browser code, or optional plug-in modules. Embedded content digital rights management may be implemented in the browser core code, in the built-in media handlers, in the plug-in media handlers, or some combination of the three.

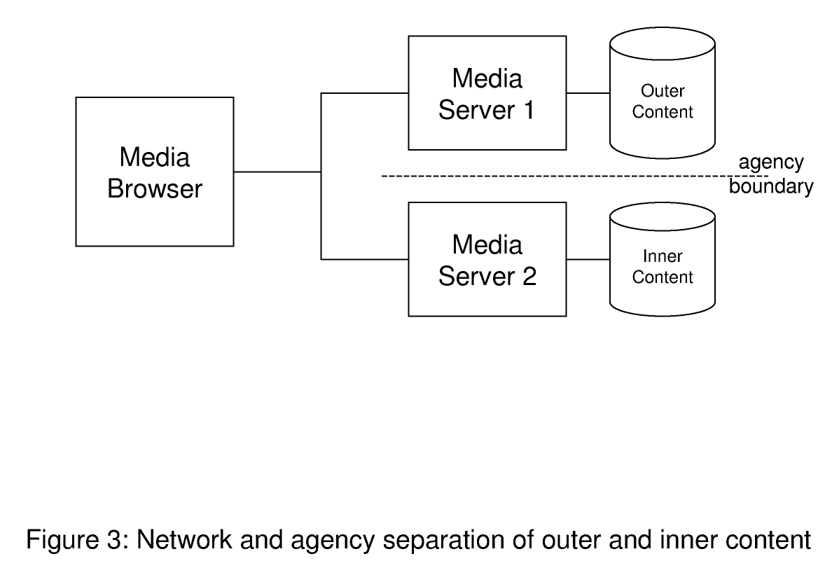

FIG. 3 shows the inner and outer content residing on separate servers, where the dotted line signifies that the servers are administered, and the content owned, by separate agencies.

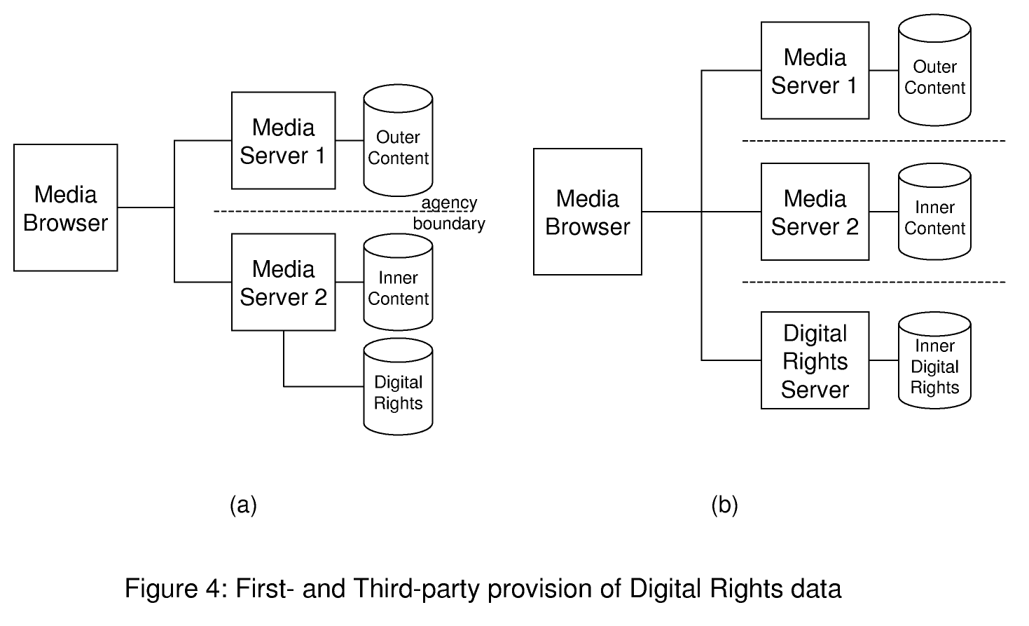

FIG. 4(a) shows an architecture where the inner content's server also stores and serves data regarding the digital rights of embedding the inner content in various outer content. (The inner content and digital rights data need not be on the same server hardware or operating system processes, but it does assume high levels of trust and communication between subsystems, so they are usually part of the same administrative entity.) This makes sense because it will typically be the owners of the inner content that have an interest in preventing digital rights abuse by outer content.

FIG. 4(b) shows an alternate architecture where the digital rights data is stored and served by a trusted third-party. That is, the third-party would be trusted by the owners of the inner content to represent the inner content regarding the digital rights of embedding in outer content.

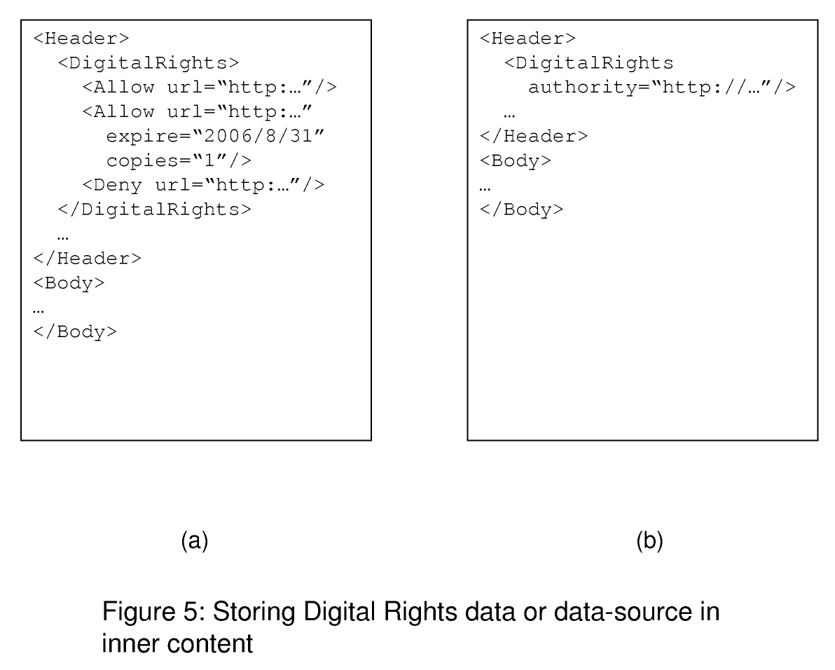

FIG. 5 shows two examples of how inner content can store digital rights information. FIG. 5(a) shows how inner content can encode embedding digital rights to a piece of outer content by encoding the outer content's URL. This encoding can include multiple outer content URLs, and use a URL pattern system such as regular expressions, common to programming languages, in order to concisely encode a variety of outer content URLs. (Identifying outer content by URL for Web browsers is our preferred embodiment of this invention, but other outer content descriptions and metadata can be used instead.)

Such encoded digital rights for a particular piece of inner content is a variation of access control. Existing access control information representation techniques may be used such as white-lists (a list of those allowed) and black-lists (a list of those denied) ranging over outer content metadata patterns.

FIG. 5(b) shows inner content indirectly identifying the digital rights data by encoding a reference to a digital rights data server provided by the inner content's owner, agent, or trusted third-party. In a Web system, the reference to the digital rights data server is by URL.

Both parts of FIG. 5 assume an XML-based media format, such as HTML, XHTML, X3D (and many others). The encoding of the digital rights data, including the XML element names, may depend on the specific media format; FIG. 5 is merely an exemplary format. Also, it is straightforward to encode analogous digital rights data in many non-XML-based formats, such as in free-form header data of 2D images. Or, digital rights data can be encoded in a separate file that is associated with an inner content file (e.g., if the inner content file is content.jpg, a browser could request a file from a different server with the same name, or from the same server with a different name like content.drd).

Another aspect of the FIG. 5 example is that the digital rights data, stored in/with inner content or on separate digital rights services, could use more than just the URLs to determine digital rights. For example, the digital rights data could include an expiration date (and optionally, time), after which the allowed URL is no longer valid. Or, digital rights data could specify a maximum number of copies of the inner content to embed in an instance of the outer content. Additional useful parameters to the digital rights determination may be used. In each case, the browser and/or network service logic will be enhanced to enforce these additional parameters.

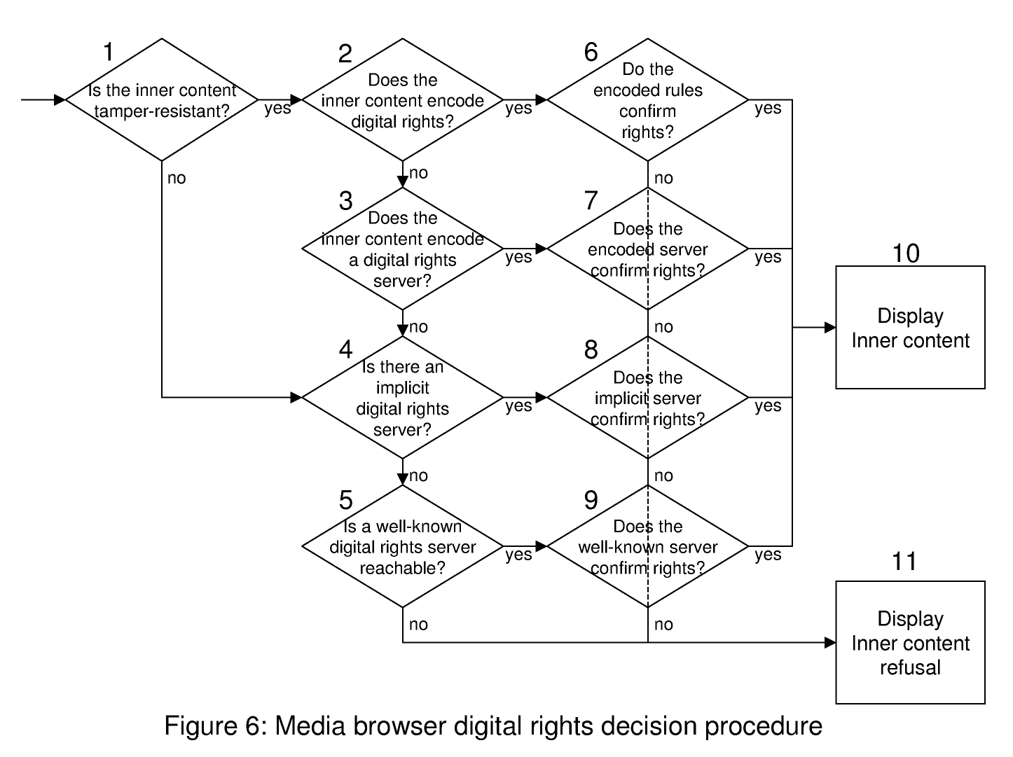

FIG. 6 shows an example decision procedure for a browser to locate, and enforce, the digital rights of inner content. Starting at flowchart box 1, the browser determines whether the inner content is tamper-resistant, before trusting any digital-rights information encoded therein (e.g., through compilation, obfustication, digital-signatures, and/or encryption. No amount of tamper-resistance is absolutely unbreakable. Browser developers or perhaps the industry as a whole may to decide on an appropriate measure of trust).

Upon being considered tamper-resistant, FIG. 6 boxes 2 and 3 are tests for the existence of digital rights information inside the inner content, as in the format examples of FIG. 5. That is, box 2 looks for outer content digital rights directly encoded into the inner content, and box 2 looks for information about a digital rights service encoded into the inner content.

FIG. 6 box 4 looks for the existence of an implicit digital rights service, which means that the network location of the service is derived from the network location of the inner content. In one example of Web browsers, servers, and URLs, the URL of an implicit digital rights service is derived from the URL of the inner content. Such a derivation can happen in many ways, e.g., if the inner content URL is http://www.domain.com/path/file.ext, potential implicit servers are
http://drm.domain.com/
drm://www.domain.com/
http://www.domain.com/drm
   and many others. Browsers will be configured to recognize some subset of these derivations and test for existence of such services in turn.

When contacting an implicit digital rights service, or a well-known (network location is known a priori to the browser) digital rights service in FIG. 6 box 5, the browser provides the metadata for both the outer and inner content, so that the service may make a digital rights determination. With Web browsers and servers, the outer and inner content URLs are part of the service request, e.g., part of the browser's HTTP request of the digital rights service. There are several ways to include such information in an HTTP request, including the request URL, request headers, and the body of the request. One example is to use a URL, such as this example:
http://drm.domain.com/path/file.ext?outer=http://www.domain2.com/path2/file2.ext
   but there are many alternatives. The digital rights service then compares the inner and outer URL information against what it knows about embedding digital rights.

FIG. 6 boxes 6-9 are all steps to compare the outer content metadata against the digital rights data, which is taken from the inner content itself in the case of box 6, and from a digital rights service in boxes 7-9. In any case, if the processing of digital rights data results in confirmation of the digital rights of the outer content to embed the inner content, then box 10 will cause display of the combination. Otherwise, box 11 will cause display of a refusal, e.g., will cause display of the outer content but in the place whether the inner content would go, this method causes the browser to display a message conveying that, based on the digital rights data, the display of the inner content is not authorized.

A further aspect is an alternative to the mere refusal message. The browser can cause display of a message conveying how to obtain digital rights for display of the inner content. For example, this message may describe payment terms and a link to a payment user interface for purchasing such digital rights. This may be especially useful when the browser's user is the owner of the outer content, as in a social network where a user is browsing his/her own personal page and attempting to embed some inner content. Another example of an alternative message is a user interface to send a message to the owner of the outer content, asking them to procure the digital rights to display the inner content.

What is claimed is:

1. A computer-implemented method for provision and use of digital rights data for embedded data over networked systems, said method comprising:
a. preparing to render “outer” content that contains a reference to “inner” content, with the semantics of rendering the inner content as a sub-part of the outer content;
b. comparison of outer content metadata with inner content metadata to see if the outer content has the digital rights to render the inner content as a sub-part;
c. based on the comparison, rendering the inner content as a sub-part of the outer content, or not.

2. The method according to claim 1 wherein the networked system is based on Internet technologies including Web browsers, Web servers, Uniform Resource Locators/Indicators (URLs/URLs) and the Hypertext Transport (HTTP) protocol, content is referenced by URL, and content metadata includes the referencing URLs.

3. The method according to claim 1 wherein inner content digital rights data may be encoded into the inner content itself, and content browsers use this data to confirm digital rights between content metadata.

4. The method according to claim 1 wherein the comparison of content metadata for the purpose of determining digital rights is performed by a network service at the request of a content browser.

5. The method according to claim 1 wherein if said comparison fails to confirm digital rights, the content browser displays information about how to acquire the digital rights to embed the inner content in the outer content.

6. The method according to claim 4 wherein if the said network service reports a lack of digital rights to the content browser, that it may also respond with information on how to acquire the necessary digital rights.

7. The method according to claim 2 wherein digital rights are encoded as a relation between inner and outer content URLs.

8. The method according to claim 7 wherein said relation between URLs is implemented as white-list and black-list specifications of URL patterns.

9. The method according to claim 2 wherein digital rights management functionality is built-in to a Web browser.

10. The method according to claim 2 wherein digital rights management functionality is part of a Web browser media-handler plug-in.

11. The method according to claim 4 wherein said network service's location is derived from the inner content location.

12. The method according to claim 11 wherein said locations are indicated by URLs.

13. The method according to claim 1 wherein said inner and outer content reside as separate networked content owned and provided by separate entities.

14. The method according to claim 1 wherein said comparison also checks an expiration date and/or time to determine digital rights.

15. The method according to claim 1 wherein said comparison also checks the number of times the inner content is embedded in the outer content.
